(19) United States
(12) Patent Application Publication
(10) Pub. No.: US 2013/0083439 A1
(43) Pub. Date: Apr. 4, 2013

(54) HIGH-FREQUENCY MODULE

(71) Applicant: Murata Manufacturing Co., Ltd., Nagaokakyo-shi (JP)

(72) Inventor: Masashi HAYAKAWA, Nagaokakyo-shi (JP)

(73) Assignee: Murata Manufacturing Co., Ltd., Nagaokakyo-shi (JP)

(21) Appl. No.: 13/688,554

(22) Filed: Nov. 29, 2012

Related U.S. Application Data
(63) Continuation of application No. PCT/JP2011/061927, filed on May 25, 2011.

(30) Foreign Application Priority Data
Jun. 1, 2010 (JP) 2010-125453

(51) Int. Cl. H02H 9/04

(52) U.S. Cl. CPC H02H 9/045
USPC 361/56

(57) ABSTRACT

A high-frequency module includes an inductor and an ESD protection element. The inductor is a circuit element defining a low pass filter, and includes parasitic capacitance between a signal line and a ground in a specific frequency band. The ESD protection element transfers a surge current flowing through a signal line to the ground, includes a capacitor in a specific frequency band, and has a configuration in which the capacitor and the parasitic capacitance of the inductor are connected in parallel.

### BACKGROUND OF THE INVENTION

1. Field of the Invention

The present invention relates to a high-frequency module equipped with an ESD (Electro-Static Discharge) protection element preventing discharge damage due to static electricity.

2. Description of the Related Art

So as to prevent damage due to static electricity, an ESD protection element is occasionally provided in a high-frequency module (for example, refer to Japanese Unexamined Patent Application Publication No. 2005-123740). The term “ESD” refers to a phenomenon in which discharge occurs when an electrically charged conductive object (a human body or the like) is in contact with or gets close enough to another conductive object (an electronic device or the like). Since a problem such as damage, malfunction, or the like of an electronic device occurs as a result of the ESD, it is necessary to prevent a current (surge current) from occurring as a result of the discharge from being applied to a circuit in the electronic device. An element used for this purpose is an ESD protection element, and is also referred to as a surge absorbing element or a surge absorber.

FIG. 1A is the circuit diagram of a high-frequency module 100 of the related art, prepared with reference to Japanese Unexamined Patent Application Publication No. 2005-123740. The high-frequency module 100 includes an ESD protection circuit 101 and an antenna switch 102, and the ESD protection circuit 101 is inserted in series between the input terminal 104 of the antenna switch 102 and the antenna terminal 103. FIG. 1B and FIG. 1C are circuit diagrams illustrating examples of the configuration of the ESD protection circuit 101. The ESD protection circuit 101 is configured by a plurality of circuit elements connected to a signal line and a ground in a T type or a π type, and has a function for preventing the damage of the antenna switch 102 by transferring a surge current from the antenna terminal 103 to the ground.

In a high-frequency module of the related art, a signal propagation distance in a signal line is extended by providing an ESD protection element, and hence a loss (conductor loss) of a signal is increased. In addition, by connecting the ESD protection element, a loss (reflection loss) of the signal is increased.

### SUMMARY OF THE INVENTION

Therefore, preferred embodiments of the present invention provide a high-frequency module that reliably prevents an extension of a signal propagation distance and an occurrence of impedance mismatching while providing an ESD protection function.

According to a preferred embodiment of the present invention, a high-frequency module includes a signal selection circuit arranged to select a specific communication signal from a plurality of communication signals propagating through an antenna, and an ESD protection element, wherein the signal selection circuit is provided between a signal line through which the communication signal flows and a ground so as to include a circuit element including a capacitance component in a frequency band of the communication signal, and the ESD protection element includes a capacitance component in the frequency band of the communication signal and a configuration where the capacitance component and the capacitance component of the circuit element are connected in parallel in an equivalent circuit in the frequency band of the communication signal.

In this configuration, since the ESD protection element is connected in parallel between the signal line and the ground, there is no extension of a signal propagation distance due to the ESD protection element in the signal line, and no increase in a transmission loss due thereto occurs. Furthermore, since the ESD protection element is connected in parallel to the circuit element configuring the signal selection circuit, the capacitance components thereof function as one combined capacitance, and it becomes possible to achieve impedance matching by setting the combined capacitance to a desired value.

Accordingly, it is possible to prevent the occurrence of impedance mismatching that results from the installation of the ESD protection element and an increase in a reflection loss as a result thereof.

It is preferred that the circuit element of a preferred embodiment of the present invention is a capacitor connected between the signal line and the ground.

In this configuration, by setting, to a desired value, the combined capacitance of a capacitance of an existing capacitor including in the signal selection circuit and a capacitance of the newly attached ESD protection element, it becomes possible to achieve impedance matching and prevent an increase in a reflection loss due to the installation of the ESD protection element.

The signal selection circuit according to a preferred embodiment of the present invention may be configured so as to include a low pass filter, and have a configuration in which the capacitor and the ESD protection element are connected in parallel to a terminal of the low pass filter, different from a terminal thereof connected to the antenna.

It is preferred that the circuit element according to a preferred embodiment of the present invention is a strip line or a microstrip line, configured by the signal line and a ground electrode facing the signal line through a dielectric layer.

In this configuration, by setting, to a desired value, the combined capacitance of a capacitance generated between the signal line of the strip line or the microstrip line and the ground electrode and a capacitance of the newly attached ESD protection element, it becomes possible to achieve impedance matching and prevent an increase in a reflection loss due to the installation of the ESD protection element.

It is preferred that the ESD protection element according to a preferred embodiment of the present invention includes a dielectric multilayer substrate, a pair of discharge electrodes, and an external electrode and has a chip configuration by being connected to the signal selection circuit through the external electrode. In addition, it is also preferred that the ESD protection element according to a preferred embodiment of the present invention has a configuration where the ESD protection element is integrated with the laminated circuit substrate in a hollow cavity portion located in the laminated circuit substrate included in the high-frequency module, a pair of discharge electrodes, and a mixing portion. In addition, the mixing portion includes a metal material and a dielectric material, and is provided at a position where the mixing portion is exposed in the hollow cavity portion. The pair of discharge electrodes includes facing portions disposed so as to face each other while being spaced from each other within the hollow cavity portion. The external electrode is connected to the discharge electrodes and located in a surface of the dielectric multilayer substrate.

In these configurations, when a voltage exceeding a predetermined amount is applied to the pair of discharge electrodes disposed within the hollow cavity portion, discharge occurs through the mixing portion, and a surge current turns out to flow into the ground. In addition, by arranging the pair of discharge electrodes as described above, the ESD protection element includes a capacitance component in the frequency band of the communication signal.

It is preferred that the signal selection circuit according to a preferred embodiment of the present invention is configured so as to include a diode switch circuit or an FET switch circuit, which processes a communication signal.

Since the materials of the diode and the FET preferably are static-sensitive semiconductors, there is a huge demand for adding an ESD protection element.

According to various preferred embodiments of the present invention, it is possible to provide a high-frequency module that reliably prevents an extension of a signal propagation distance and the occurrence of impedance mismatching while providing an ESD protection function.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A-1C are diagrams illustrating a configuration of a high-frequency module of the related art.

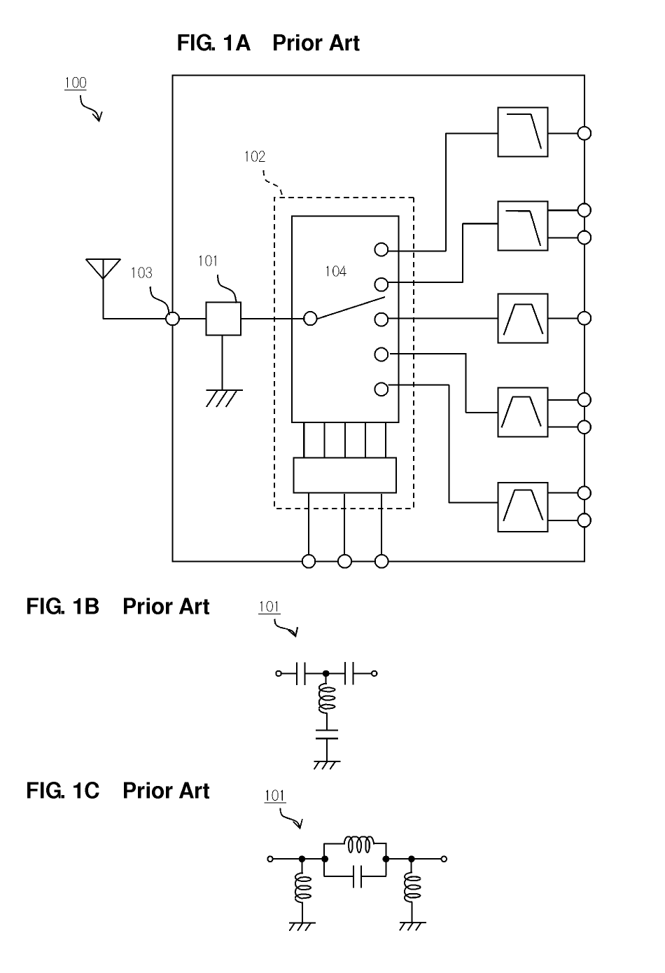

FIG. 2 is a circuit diagram of a high-frequency module according to a first preferred embodiment of the present invention.

FIG. 3 is a lamination diagram of a high-frequency module according to the first preferred embodiment of the present invention.

FIGS. 4A and 4B are cross-sectional views of a high-frequency module according to the first preferred embodiment of the present invention.

FIG. 5 is a circuit diagram of a high-frequency module according to a second preferred embodiment of the present invention.

FIG. 6 is a lamination diagram of a high-frequency module according to the second preferred embodiment of the present invention.

FIG. 7 is a circuit diagram of a high-frequency module according to a third preferred embodiment of the present invention.

FIG. 8 is a lamination diagram of a high-frequency module according to the third preferred embodiment of the present invention.

FIGS. 9A and 9B are cross-sectional views of a high-frequency module according to a fourth preferred embodiment of the present invention.

### DETAILED DESCRIPTION OF THE PREFERRED EMBODIMENTS

### First Preferred Embodiment

A high-frequency module according to a first preferred embodiment of the present invention will be described with a high-frequency module 11 compatible with four communication signals based on GSM850, GSM900, GSM1800, and GSM1900 being cited as an example.

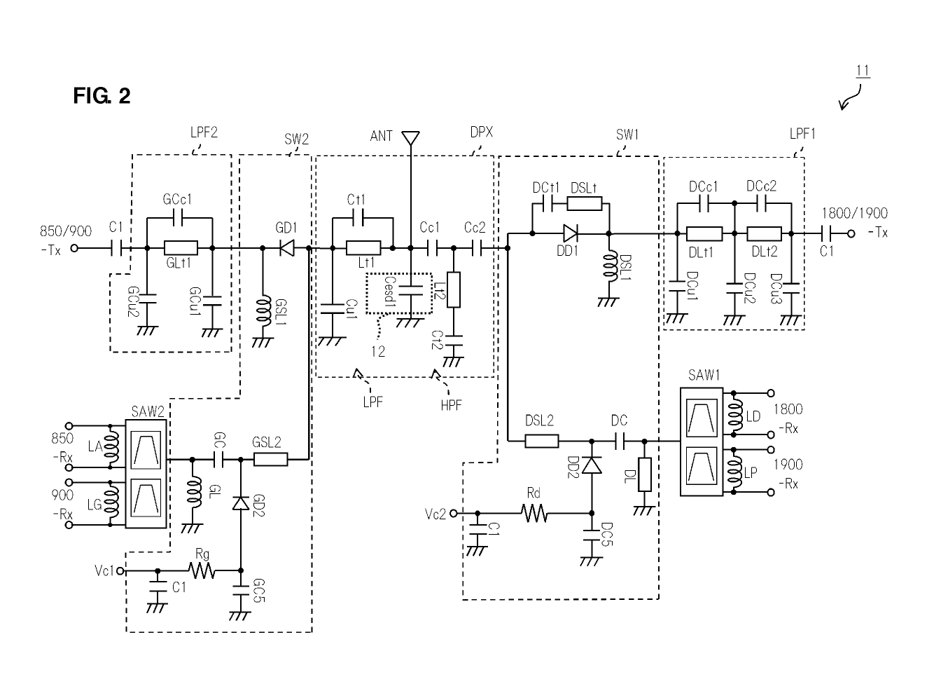

FIG. 2 is a circuit diagram illustrating the detailed circuit configuration of the high-frequency module 11.

The high-frequency module 11 includes an ESD protection element 12, a diplexer DPX, switch circuits SW1 and SW2, low pass filters LPF1 and LPF2, and surface elastic wave filters SAW1 and SAW2. A signal selection circuit preferably includes the diplexer DPX, the switch circuits SW1 and SW2, and the low pass filters LPF1 and LPF2. In addition, an antenna port ANT, signal ports 1800/1900-Tx, 1800-Rx, 1900-Rx, 850/900-Tx, 850-Rx, and 900-Rx, and control ports Vc1 and Vc2 are preferably included as external connection ports.

The diplexer DPX includes a low pass filter LPF and a high pass filter HPF. The antenna port ANT is connected to a connection point between the low pass filter LPF and the high pass filter HPF in the diplexer DPX, and the ESD protection element 12 is connected to the connection point.

The ESD protection element 12 is an element that defines a capacitor Cesd1 of low capacitance (for example, about 0.05 pF) in at least the communication band of the corresponding high-frequency module, and connected between the antenna port ANT and a ground. When a surge current is applied to a signal line from the antenna port ANT, the capacitor Cesd1 is short-circuited, and causes the surge current to flow into the ground.

The high pass filter HPF is a high pass filter causing signals of GSM1800 and GSM1900 to pass therethrough and attenuating signals of GSM850 and GSM900. In more detail, the high pass filter HPF preferably includes capacitors Cc1 and Cc2, an inductor Lt2, and a capacitor Ct2, and includes a series circuit including the capacitors Cc1 and Cc2 provided in a signal line between the antenna port ANT and the switch circuit SW1, and connects a connection point between the capacitors Cc1 and Cc2 to the ground through a series circuit including the inductor Lt2 and the capacitor Ct2.

The low pass filter LPF is a low pass filter causing the signals of GSM850 and GSM900 to pass therethrough and attenuating the signals of GSM1800 and GSM1900. The low pass filter LPF includes a capacitor Ct1, an inductor Lt1, and a capacitor Cu1. In more detail, the inductor Lt1 and the capacitor Ct1 connected in parallel to the inductor Lt1 are inserted between the antenna port ANT and the switch circuit SW2, and the capacitor Cu1 is inserted between a connection point among the inductor Lt1, capacitor Ct1, and the switch circuit SW2 and a ground electrode. Accordingly, the low pass filter LPF is provided.

The switch circuit SW1 includes a diode DD1, an inductor DSLt, a capacitor DCt1, an inductor DSL1, an inductor DSL2, a capacitor DC, an inductor DL, a diode DD2, a capacitor DC5, a resistor Rd, and a capacitor C1, and separates the transmission signals and the reception signals of GSM1800 and GSM1900.

The switch circuit SW2 includes a diode GD1, an inductor GSL1, an inductor GSL2, a capacitor GC, an inductor GL, a diode GD2, a capacitor GC5, a resistor Rg, and a capacitor C1, and separates the transmission signals and the reception signals of GSM850 and GSM900.

The low pass filter LPF1 includes inductors DLt1 and DLt2, capacitors DCc1 and DCc2, and capacitors DCu1, DCu2, and DCu3, and defines a low pass filter that removes the second harmonic wave components and the third harmonic wave components of the transmission signals of GSM1800 and GSM1900.

The low pass filter LPF2 includes an inductor GLt1, a capacitor GCc1, and capacitors GCu1 and GCu2, and defines a low pass filter that removes the second harmonic wave components and the third harmonic wave components of the transmission signals of GSM850 and GSM900.

The surface elastic wave filter SAW1 separates the reception signal of GSM1800 and the reception signal of GSM1900. The surface elastic wave filter SAW2 separates the reception signal of GSM850 and the reception signal of GSM900.

In addition, since the configurations of the switch circuits SW1 and SW2, the low pass filters LPF1 and LPF2, and the surface elastic wave filters SAW1 and SAW2 are well known, the detailed descriptions thereof will be omitted.

In the above-mentioned configuration, in the past, circuit elements configuring the signal selection circuit, in particular, the diode GD1 or the diode GD2 in the switch circuit SW2 has been at a high risk that discharge damage occurs as a result of an application of a surge current from the antenna port ANT. However, in the present preferred embodiment, since the ESD protection element 12 is connected on a side near to the antenna port ANT, compared with these diodes GD1 and GD2, it is possible to protect the diodes GD1 and GD2 from the discharge damage.

In addition, the ESD protection element 12 provided in the diplexer DPX is not connected in series to a signal line connected from the antenna port ANT to each signal port but connected in parallel between the signal line and the ground. Accordingly, even if the ESD protection element 12 is provided in the diplexer DPX, this results in no extension of a signal propagation distance and no increase in a transmission loss.

Furthermore, the inductor Lt1 in the low pass filter LPF preferably has the structure of a strip line, described later in detail, corresponds to a circuit element including a capacitance component, and includes a capacitance component (not illustrated) between a signal line and the ground. Accordingly, this capacitance is connected between the signal line and the ground, and connected in parallel to the ESD protection element functioning as the capacitor Cesd1. While usually this capacitance is set to an adequate setting value so as to adjust the frequency characteristic of the diplexer DPX, in the present preferred embodiment, by adequately setting the combined capacitance including the capacitance (not illustrated) of the inductor Lt1 and the capacitor Cesd1, it is possible to prevent deviation of impedance matching (mismatching) and an increase in a reflection loss due thereto.

Next, the detailed configuration of a laminated circuit substrate 11A defining the high-frequency module 11 will be described.

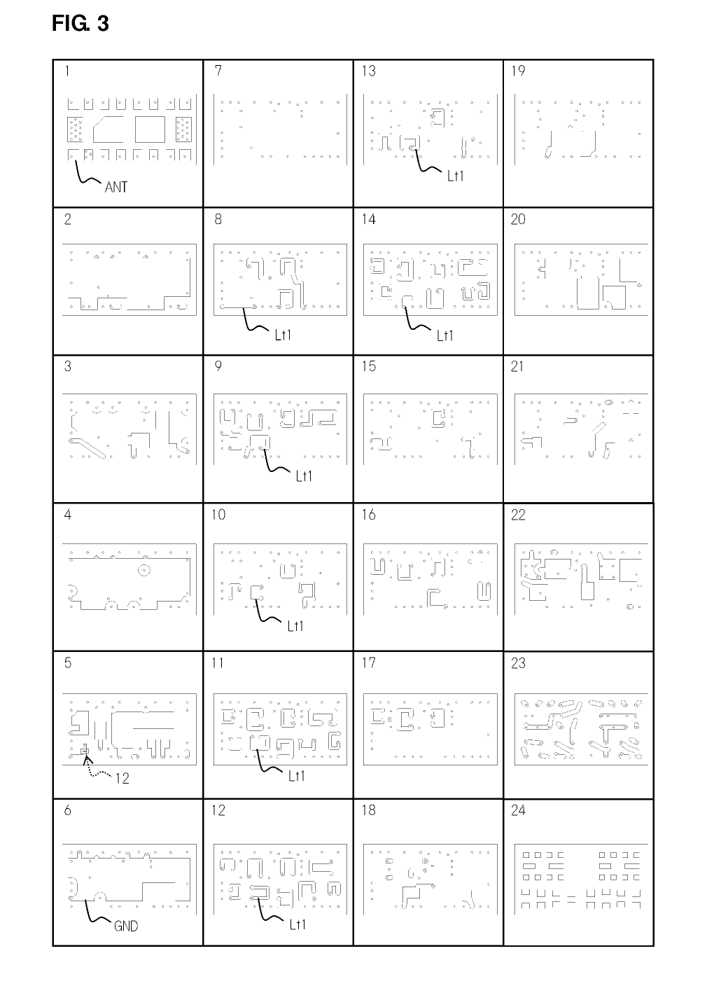

FIG. 3 is a lamination diagram explaining a specific example of the laminated circuit substrate 11A.

In addition, in FIG. 3, it is assumed that the layer of the bottom surface of the laminated circuit substrate 11A is a first layer, a layer number increases toward an upper surface side, and the layer of the upper surface of the laminated circuit substrate 11A is a twenty-fourth layer, for example. Symbols included in the drawing individually correspond to the circuit configurations illustrated in FIG. 2. In addition, 0 symbols included in the drawing indicate conductive via holes, and secure conductivity between electrodes of individual layers aligned in a lamination direction.

The laminated circuit substrate 11A has a structure in which dielectric layers, the number of layers of which is 24 in total, for example, are laminated, and defines various kinds of inductors, capacitors, and the like owing to internal electrode patterns. In addition, the laminated circuit substrate 11A provides each port defined by the electrode pattern of a substrate bottom surface, and provides an electrode to which a chip-type mounted component is connected, defined by the electrode pattern of a substrate upper surface.

On a bottom surface side of the first layer corresponding to the bottom surface of the laminated circuit substrate 11A, electrode patterns to define a plurality of ports including the antenna port ANT are provided. The antenna port ANT extends from the first layer to a fourth layer through via holes, and is connected to an internal electrode pattern provided in a fifth layer. This internal electrode pattern configures a portion of the ESD protection element 12.

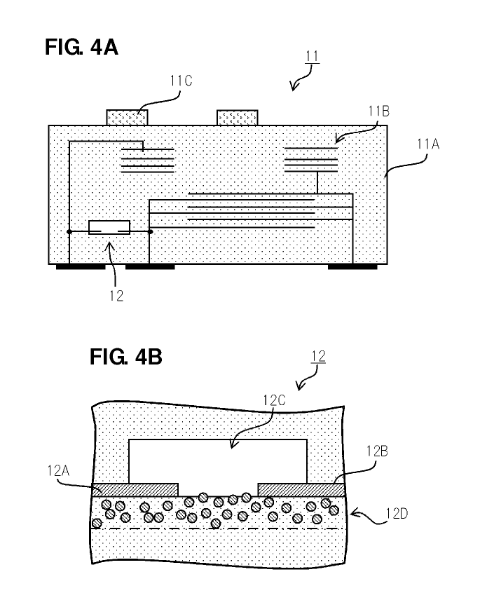

Here, the outline configuration of the ESD protection element 12 will be described. FIG. 4A is the cross-sectional view of the high-frequency module 11, and FIG. 4B is the cross-sectional view of the ESD protection element 12.

The high-frequency module 11 has a configuration in which a plurality of circuit elements 11B and 11C and the ESD protection element 12 are provided in the laminated circuit substrate 11A. As described in the above-mentioned FIG. 3, the laminated circuit substrate 11A is formed preferably by laminating a plurality of dielectric layers including ceramic, resin, or the like. The circuit element 11B preferably is formed between individual dielectric layers in the laminated circuit substrate 11A or in the front surface thereof, using predetermined patterns, and the circuit element 11C preferably is a chip-type mounted component disposed within the laminated circuit substrate 11A or in the top surface thereof. The ESD protection element 12 includes a hollow cavity portion 12C provided within the laminated circuit substrate 11A, discharge electrodes 12A and 12B the leading ends of which protrude into the hollow cavity portion 12C, and a mixing portion 12D, formed by dispersing metal particles in a portion of the region of a dielectric layer in the laminated circuit substrate 11A and partially exposed in the hollow cavity portion 12C. Each of the discharge electrodes 12A and 12B is laminated in the front surface of the mixing portion 12D, and configures facing portions where the leading ends thereof face each other while being spaced from each other within the hollow cavity portion 12C.

With respect to the ESD protection element 12 having such a configuration, when one of the discharge electrodes 12A and 12B is connected to a signal line through which a communication signal from an antenna flows and the other of the discharge electrodes 12A and 12B is connected to the ground, capacitance is included between the discharge electrodes 12A and 12B in a high-frequency manner. In addition, when a surge current is applied to the signal line, the discharge electrodes 12A and 12B are short-circuited therebetween through the metal particles in the mixing portion 12D, and the surge current flows into the ground. Accordingly, it becomes possible to prevent the damage of the high-frequency module 11 due to the surge current.

In addition, it is only necessary for the ESD protection element 12 to have a configuration including at least the discharge electrodes 12A and 12B, and a configuration may also be adopted where the discharge electrodes 12A and 12B are caused to be very close to each other with the mixing portion 12D not being provided. In addition, the ESD protection element 12 may not be configured as a substrate-integrated configuration of being configured to be integrated with the laminated circuit substrate 11A but may also be configured as the chip-type circuit element 11C configured separately from the laminated circuit substrate 11A.

Returning to FIG. 3 again, FIG. 3 will be described. In the above-mentioned ESD protection element 12, a hollow cavity portion 11C (a symbol is not illustrated) is formed by hollowing the fifth layer in the laminated circuit substrate 11A, and one of the discharge electrodes 12A and 12B (symbols are not illustrated) is connected to a ground electrode provided in a sixth layer.

In addition, the antenna port ANT extends from the first layer to an eighth layer owing to via holes, and is connected to the inductor Lt1 including electrode patterns provided in the eighth layer to a fourteenth layer. The inductor Lt1 preferably has a strip line structure in which the internal electrode patterns of the eighth layer to the fourteenth layer face the ground electrode GND provided in the sixth layer through dielectric layers, and includes a capacitance component arranged in a high-frequency manner.

In the high-frequency module 11 of the present preferred embodiment, at least one of the inductor Lt1 and the ESD protection element 12 is adjusted so that the combined capacitance of the capacitance of the inductor Lt1 and the capacitance of the ESD protection element 12 becomes equivalent to the capacitance of the inductor Lt1 in the structure of the related art where no ESD protection element 12 is provided. It is possible to adjust the capacitance of the inductor Lt1 by changing a facing area between internal electrode patterns configuring the inductor Lt1 and the ground electrode, and it is possible to adjust the capacitance of the ESD protection element 12 by changing a distance between the discharge electrodes 12A and 12B.

Accordingly, in this high-frequency module 11, it is possible to prevent deviation of impedance matching and an increase in a reflection loss, which are due to the influence of the ESD protection element 12.

### Second Preferred Embodiment

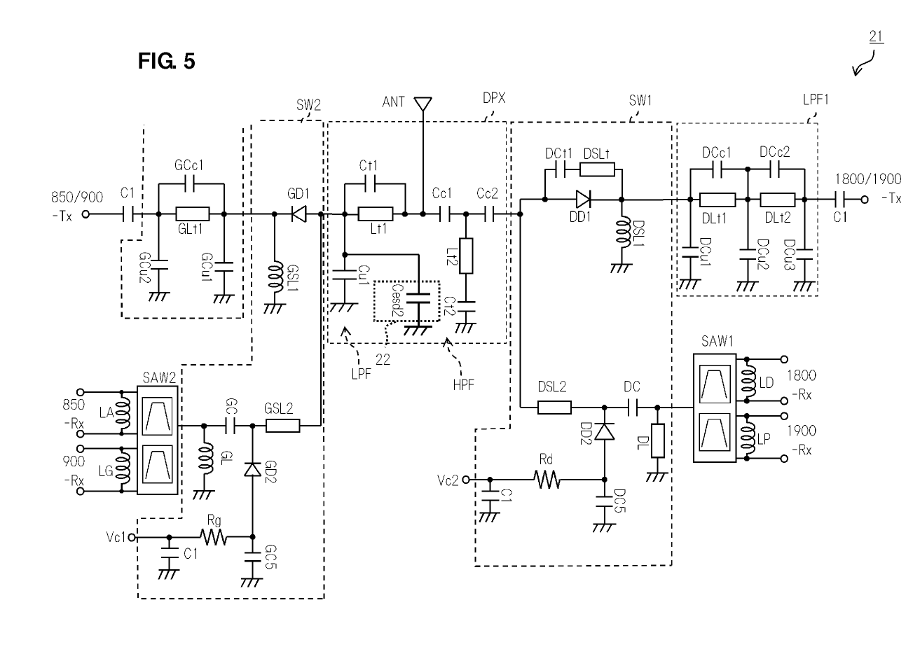

Next, a high-frequency module according to a second preferred embodiment of the present invention will be described. FIG. 5 is the circuit diagram of a high-frequency module 21 of the present preferred embodiment.

The high-frequency module 21 of the present preferred embodiment is different from the high-frequency module 11 of the first preferred embodiment in the connecting position of an ESD protection element 22. Specifically, the ESD protection element 22 is not connected to the connection point between the antenna port ANT and the inductor Lt1 but connected to a connection point between the inductor Lt1 and the capacitor Cu1.

The ESD protection element 22 is an element functioning as a capacitor Cesd2 of low capacitance (for example, about 0.05 pF) in the communication band of the corresponding high-frequency module, and when a surge current is applied to a signal line from the antenna port ANT, the capacitor Cesd2 is short-circuited, and causes the surge current to flow into the ground. The capacitor Cu1 corresponds to a circuit element having a capacitance component, and is connected in parallel to the capacitor Cesd2 with being connected between the signal line and the ground.

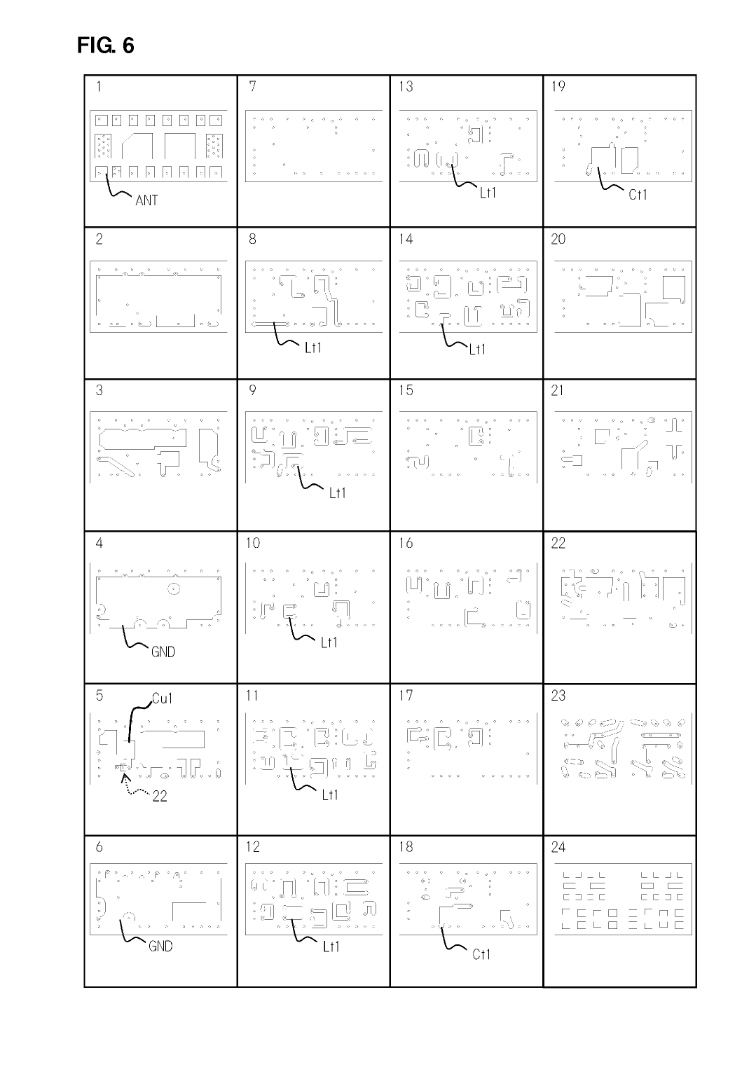

FIG. 6 is the lamination diagram of the high-frequency module 21. In a laminated circuit substrate defining the high-frequency module 21, the antenna port ANT extends from the first layer to the eighth layer through via holes, and is connected to the inductor Lt1. The inductor Lt1 includes electrode patterns provided in the eighth layer to the fourteenth layer. In addition, the inductor Lt1 extends from the thirteenth layer to the fifth layer through via holes, and is connected to the capacitor Cu1. An internal electrode pattern provided in the fifth layer and ground electrodes provided in the fourth layer and the sixth layer face each other, and hence, the capacitor Cu1 is provided. The ESD protection element 22 is connected between the internal electrode pattern serving as one electrode, which defines the capacitor Cu1 and is provided in the fifth layer, and the ground electrode serving as the other electrode that defines the capacitor Cu1 and is provided in the sixth layer. Accordingly, the ESD protection element and the capacitor Cu1 are connected in parallel.

In the high-frequency module 21 of the present preferred embodiment, a facing area between a pair of facing electrodes defining the capacitor Cu1 is reduced compared with that of the related art, and the combined capacitance of the capacitance of the capacitor Cu1 and the capacitance of the capacitor Cesd2 is caused to be equivalent to the capacitance of the capacitor Cu1 in the structure of the related art (a structure where no ESD protection element 22 is provided). Accordingly, in this high-frequency module 21, it is possible to prevent deviation of matching due to the influence of the ESD protection element 22 and the occurrence of a reflection loss due thereto.

### Third Preferred Embodiment

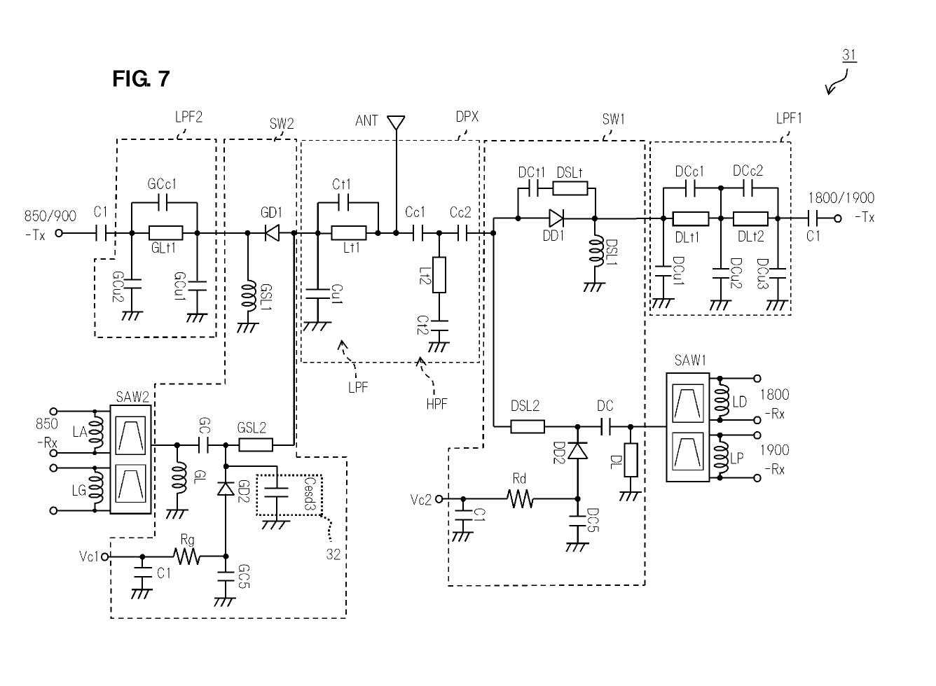

Next, a high-frequency module according to a third preferred embodiment of the present invention will be described. FIG. 7 is the circuit diagram of a high-frequency module 31 of the present preferred embodiment.

The high-frequency module 31 of the present preferred embodiment is different from the high-frequency module 11 of the first preferred embodiment and the high-frequency module 21 of the second preferred embodiment, in the connecting position of an ESD protection element 32. Specifically, the ESD protection element 32 is not connected to the diplexer DPX but connected to a connection point among the inductor GSL2 of the switch circuit SW2, the diode GD2, and the capacitor GC.

The ESD protection element 32 is an element defining a capacitor Cesd3 of low capacitance (for example, about 0.05 pF) in the communication band of the corresponding high-frequency module, and when a surge current is applied from the inductor GSL2 to the capacitor GC and the diode GD2 through a signal line, the capacitor Cesd3 is short-circuited, and causes the surge current to flow into the ground. The inductor GSL2 corresponds to a circuit element described herein, preferably has a strip line structure including a capacitance component connected between the signal line and the ground in the same way as the inductor Lt1 of the first preferred embodiment, and is connected in parallel to the capacitor Cesd3.

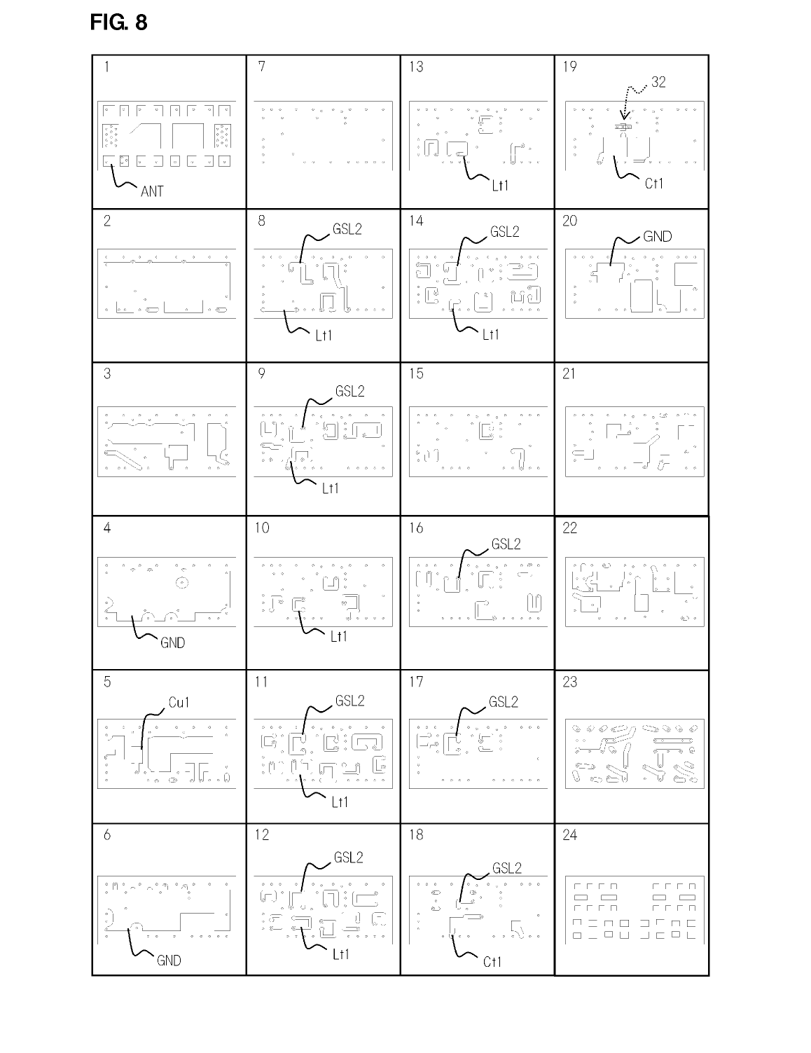

FIG. 8 is the lamination diagram of the high-frequency module 31.

In the laminated circuit substrate of the high-frequency module 31, the inductor GSL2 preferably has a strip line structure where internal electrode patterns provided in the eighth layer to the eighteenth layer face the ground electrode GND provided in the sixth layer through dielectric layers, and includes a capacitance component arranged in a high-frequency manner. Internal electrode patterns defining the inductor GSL2 are connected to one end of the ESD protection element 32 provided in a nineteenth layer, through a via hole provided in the eighteenth layer. In addition, the other end of the ESD protection element 32 is connected to a ground electrode GND provided in a twentieth layer, through a via hole provided in the nineteenth layer. Accordingly, the inductor GSL2 and the ESD protection element 32 are connected in parallel between the signal line and the ground.

In the high-frequency module 31 of the present preferred embodiment, the combined capacitance of the capacitance of the inductor GSL2 and the capacitance of the capacitor Cesd3 is adjusted so as to be equivalent to the capacitance of the inductor GSL2 in the structure of the related art. Accordingly, in this high-frequency module 31, it is possible to prevent deviation of matching and the occurrence of a reflection loss, which are caused by the influence of the ESD protection element 32.

### Fourth Preferred Embodiment

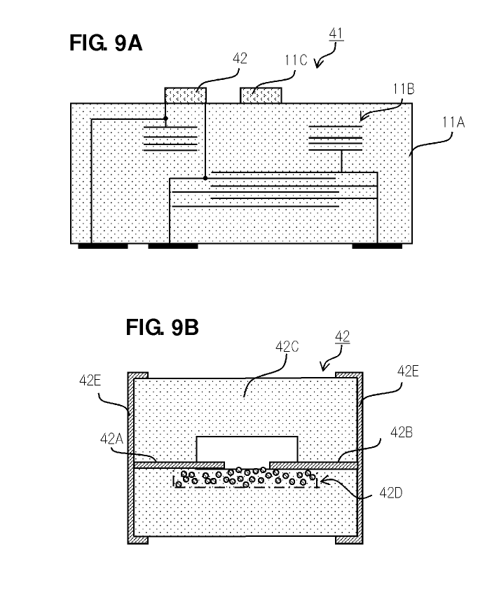

Next, a high-frequency module according to a fourth preferred embodiment of the present invention will be described. FIG. 9A is a cross-sectional view of a high-frequency module 41 of the present preferred embodiment, and FIG. 9B is a cross-sectional view of an ESD protection element 42 included in the high-frequency module 41.

The high-frequency module 41 of the present preferred embodiment has a configuration including the ESD protection element 42 that is not a substrate-integrated type element but a chip type element. The ESD protection element 42 includes a cavity 42C serving as a dielectric multilayer substrate including an inner hollow cavity, discharge electrodes 42A and 42B the leading ends of which face each other within the inner hollow cavity of the cavity 42C, and an external electrode 42E conductively connected to the discharge electrodes 42A and 42B, and has a configuration in which a portion of the inner wall surface of the cavity 42C serves as a mixing portion 42D and the external electrode 42E is provided in the outer surface of the cavity 42C.

Also in this high-frequency module 41, by adopting the same circuit configuration as the above-mentioned circuit configuration of each preferred embodiment, while realizing an ESD protection function, it becomes possible to prevent an increase in a transmission loss and the occurrence of impedance mismatching, which result from the installation of the ESD protection element 42.

While the present invention may be implemented in such a way as described and illustrated with respect to each of the above preferred embodiments, since a semiconductor circuit element connected directly or through an inductor to an antenna port is at high risk of being damaged owing to a surge, it is desirable that the ESD protection element of a preferred embodiment of the present invention is certainly provided between a signal line leading from the antenna port to the semiconductor circuit element and a ground.

In addition, as for the placement position of an ESD protection element, from a viewpoint of the certainty of protection from damage due to a surge current, it is desirable that the ESD protection element is disposed as close to a circuit element to be protected as possible, away from an antenna side, and it is suitable that a plurality of ESD protection elements are also provided when there are a plurality of circuit elements to be protected. On the other hand, from a viewpoint of downsizing, it is suitable that the ESD protection element is located anterior to the branch of a signal line from the antenna.

In addition, a preferred embodiment of the present invention may also be applied to not only the diplexer but also the configuration or the like of a switch module or another multiband-compatible or single-band-compatible high-frequency module.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A high-frequency module comprising:
a signal selection circuit arranged to select a specific communication signal from a plurality of communication signals propagating through an antenna; and
an ESD protection element; wherein
the signal selection circuit is located between a signal line through which the specific communication signal flows and a ground, and includes a circuit element including a capacitance component in a frequency band of the specific communication signal; and
the ESD protection element includes a capacitance component in the frequency band of the specific communication signal; wherein
the capacitance component of the ESD protection element and the capacitance component of the circuit element are connected in parallel in an equivalent circuit in the frequency band of the specific communication signal.

2. The high-frequency module according to claim 1, wherein the circuit element is a capacitor connected between the signal line and the ground.

3. The high-frequency module according to claim 2, wherein the signal selection circuit includes a low pass filter, and the capacitor and the ESD protection element are connected in parallel to a terminal of the low pass filter that is different from a terminal thereof connected to the antenna.

4. The high-frequency module according to claim 1, wherein the circuit element is a strip line or a microstrip line defined by the signal line and a ground facing the signal line through a dielectric layer.

5. The high-frequency module according to claim 1, wherein
the ESD protection element is a chip element including a dielectric multilayer substrate within which a hollow cavity portion is provided, a discharge electrode pair including facing portions, leading ends of which are disposed so as to face each other and are spaced from each other within the hollow cavity portion, and an external electrode provided on a surface of the dielectric multilayer substrate and connected to the discharge electrode, wherein the dielectric multilayer substrate includes a mixing portion including a metal material and a dielectric material, the mixing portion being disposed in an area of a surface in which the discharge electrode is provided and being disposed adjacent to at least the facing portions and a portion between the facing portions; and
the ESD protection element is connected to the signal selection circuit through the external electrode.

6. The high-frequency module according to claim 2, wherein
the ESD protection element is a chip element including a dielectric multilayer substrate within which a hollow cavity portion is provided, a discharge electrode pair including facing portions, leading ends of which are disposed so as to face each other and are spaced from each other within the hollow cavity portion, and an external electrode provided on a surface of the dielectric multilayer substrate and connected to the discharge electrode, wherein the dielectric multilayer substrate includes a mixing portion including a metal material and a dielectric material, the mixing portion being disposed in an area of a surface in which the discharge electrode is provided and being disposed adjacent to at least the facing portions and a portion between the facing portions; and
the ESD protection element is connected to the signal selection circuit through the external electrode.

7. The high-frequency module according to claim 3, wherein
the ESD protection element is a chip element including a dielectric multilayer substrate within which a hollow cavity portion is provided, a discharge electrode pair including facing portions, leading ends of which are disposed so as to face each other and are spaced from each other within the hollow cavity portion, and an external electrode provided on a surface of the dielectric multilayer substrate and connected to the discharge electrode, wherein the dielectric multilayer substrate includes a mixing portion including a metal material and a dielectric material, the mixing portion being disposed in an area of a surface in which the discharge electrode is provided and being disposed adjacent to at least the facing portions and a portion between the facing portions; and
the ESD protection element is connected to the signal selection circuit through the external electrode.

8. The high-frequency module according to claim 4, wherein
the ESD protection element is a chip element including a dielectric multilayer substrate within which a hollow cavity portion is provided, a discharge electrode pair including facing portions, leading ends of which are disposed so as to face each other and are spaced from each other within the hollow cavity portion, and an external electrode provided on a surface of the dielectric multilayer substrate and connected to the discharge electrode, wherein the dielectric multilayer substrate includes a mixing portion including a metal material and a dielectric material, the mixing portion being disposed in an area of a surface in which the discharge electrode is provided and being disposed adjacent to at least the facing portions and a portion between the facing portions; and
the ESD protection element is connected to the signal selection circuit through the external electrode.

9. The high-frequency module according to claim 1, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

10. The high-frequency module according to claim 2, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

11. The high-frequency module according to claim 3, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

12. The high-frequency module according to claim 4, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

13. The high-frequency module according to claim 5, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

14. The high-frequency module according to claim 6, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

15. The high-frequency module according to claim 7, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

16. The high-frequency module according to claim 8, wherein the ESD protection element includes a laminated circuit substrate including a dielectric layer and an electrode layer laminated on each other and in which the signal selection circuit is provided;
a hollow cavity portion is provided within the laminated circuit substrate;
a discharge electrode pair is provided within the laminated circuit substrate and includes facing portions, leading ends of which are disposed so as to face each other and are spaced from each other within the hollow cavity portion; and
the dielectric layer includes a mixing portion including a metal material and a dielectric material, the mixing portion being disposed in an area of a surface in which the discharge electrode is provided and being disposed adjacent to at least the facing portions and a portion between the facing portions; wherein
the ESD protection element includes the hollow cavity portion, the discharge electrode pair, and the mixing portion, and is connected to the signal selection circuit through an external electrode pair.

17. The high-frequency module according to claim 1, wherein the signal selection circuit includes a diode switch circuit or an FET switch circuit arranged to process a communication signal.

18. The high-frequency module according to claim 2, wherein the signal selection circuit includes a diode switch circuit or an FET switch circuit arranged to process a communication signal.

19. The high-frequency module according to claim 3, wherein the signal selection circuit includes a diode switch circuit or an FET switch circuit arranged to process a communication signal.

20. The high-frequency module according to claim 4, wherein the signal selection circuit includes a diode switch circuit or an FET switch circuit arranged to process a communication signal.
